(19) United States
(12) Patent Application Publication
(10) Pub. No.: US 2017/0222371 A1
(43) Pub. Date: Aug. 3, 2017

(54) METHOD FOR MANUFACTURING METAL SHELL AND ELECTRICAL CONNECTOR THEREOF

(71) Applicant: Lotes Co., Ltd, Keelung (TW)

(72) Inventor: Hao Zhang, Keelung (TW)

(21) Appl. No.: 15/213,535

(22) Filed: Jul. 19, 2016

(30) Foreign Application Priority Data
Feb. 3, 2016 (CN) 201610073057.3

(51) Int. Cl. H01R 13/6585; H01R 13/631

(52) U.S. Cl. CPC H01R 13/6585; H01R 13/631

(57) ABSTRACT

A method for manufacturing a metal shell of an electrical connector, includes: S1: providing a tube, where a mating opening is formed at an opening of the tube, for a tongue of a mating connector to be inserted therein; S2: rolling a perimeter of the mating opening inward to form a flanging, where the flanging is configured to guide the mating connecter to enter the tube; and S3: cutting the flanging using laser, so that an aperture of the mating opening is enlarged to a predetermined size. A metal shell manufactured by the above method, and an electrical connector having the metal shell.

### CROSS-REFERENCE TO RELATED APPLICATION

This non-provisional application claims priority under 35 U.S.C. §119(a) on Patent Application No. 201610073057.3 filed in P.R. China on Feb. 3, 2016, the entire content of which is hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to a method for manufacturing a metal shell and an electrical connector thereof, and in particular to a method for manufacturing a metal shell, and an electrical connector having the metal shell and used for transmitting a high-frequency signal.

### BACKGROUND OF THE INVENTION

Chinese Patent Application No. CN 201510007300.7 discloses an electrical connector including an insulation body and a metal shell wrapping the insulation body, and a method for manufacturing the metal shell. The method includes the following steps: Step 1: providing a metal tube, and cutting the metal tube to form a shell of a predetermined length; then, proceed to step S2: flaring one end of the shell, so that the shell is formed with a first tube and a second tube extending backward from the first tube, where the aperture of the second tube is greater than the aperture of the first tube; then, proceed to step S3: disposing a positioning hole on each of an upper surface and a lower surface of the second tube, where a retaining portion extends from a side of the positioning hole into the positioning hole; then, proceed to step S4: chamfering a front edge of the first tube, which is used to guide insertion of a mating connector, where the chamfering is flanging the front edge of the first tube to the inner side of the first tube, and an opening of the first tube is formed with an elliptic mating frame mouth. However, after the front edge of the first tube is flanged to the inner side of the first tube, the mating frame mouth becomes smaller; it is hard to ensure that an actual size of the mating frame mouth is consistent with a predetermined size, which results in that the metal shell and the insulation body cannot be matched with the mating connector.

Therefore, a heretofore unaddressed need exists in the art to address the aforementioned deficiencies and inadequacies.

### SUMMARY OF THE INVENTION

In one aspect, the present invention relates to a method for manufacturing a metal shell of an electrical connector. In one embodiment, the method includes:

S1: providing a tube, wherein a mating opening is formed at an opening of the tube, for a tongue of a mating connector to be inserted therein;

S2: rolling a perimeter of the mating opening inward to form a flanging, wherein the flanging is configured to guide the mating connecter to enter the tube; and

S3: cutting the flanging using laser, so that an aperture of the mating opening is enlarged to a predetermined size.

In one embodiment, after the step of S3, a plurality of protruding ribs is formed at a cut surface of the flanging, and the method further includes:

physically polishing the protruding ribs.

In one embodiment, the method further includes, concurrently at the step of S3:

blowing high-pressure air, wherein a pressure of the high-pressure air is in a range of about 0.5 MPa-2 MPa.

In one embodiment, the method further includes, concurrently at the step of S3:

blowing a high-pressure inert gas, wherein a pressure of the high-pressure inert gas is in a range of about 0.5 MPa-2 MPa.

In one embodiment, a laser head is configured to transmit the laser, and when the laser cuts the flanging, the metal shell moves relative to the laser head.

In one embodiment, when the laser cuts the flanging, the laser head is static, the metal shell is located on a seat, and the seat moves to drive the metal shell to move.

In one embodiment, the method further includes:
flaring an end of the tube that is opposite to the mating opening of the tube, so as to form a first frame and a second frame extending backwards from the first frame, where an aperture of the second frame is greater than an aperture of the first frame.

In another aspect, the present invention relates to a metal shell of an electrical connector manufactured by the method described above. The metal shell includes a tube. The tube has a mating opening formed at an opening of the tube. The mating opening is configured for a tongue of a mating connector to be inserted therein. A perimeter of the mating opening is rolled inside the tube to form a flanging. The flanging is configured to guide the mating connector to enter the tube. A plate thickness surface of the flanging is cut using laser to form a chamfer.

In one embodiment, the chamfer enables an aperture of the mating opening to gradually become larger in an insertion direction of the metal shell.

In a further aspect, the present invention relates to an electrical connector. The electrical connector includes a metal shell as described above, and an electrical body accommodated in the metal shell. Specifically, in one embodiment, the metal shell includes a tube. The tube has a mating opening formed at an opening of the tube. The mating opening is configured for a tongue of a mating connector to be inserted therein. A perimeter of the mating opening is rolled inward to form a flanging. The flanging is configured to guide the mating connector to enter the tube. A plate thickness surface of the flanging is cut using laser to form a chamfer.

In one embodiment, the electrical body includes:

an insulating body, accommodated in the metal shell and stopped by the flanging;

a first terminal group and a second terminal group received in the insulation body and disposed in an upper row and a lower row;

an upper shielding sheet, retained to the insulation body and located above the first terminal group;

a middle shielding sheet, retained to the insulation body, and located between the first terminal group and the second terminal group; and

a lower shielding sheet, retained to the insulation body, and located below the second terminal group,

where each of the upper shielding sheet and the lower shielding sheet are provided with a grounding portion in contact with the metal shell.

In one embodiment, a positioning hole is disposed respectively on each of an upper surface and a lower surface of the metal shell, a protruding block is disposed respectively on each of an upper surface and a lower surface of the insulating body, and the protruding blocks of the insulating body are respectively fixedly to the positioning holes of the metal shell.

In one embodiment, the chamfer connects an outer surface of the flanging to an inner surface of the flanging.

In one embodiment, the chamfer connects an outer surface of the flanging to an inner surface of the flanging.

In one embodiment, the insulating body has a concave portion, and the chamfer is received in the concave portion.

Compared with the related art, in certain embodiments of the present invention, after a perimeter of a mating opening of the tube is rolled to the inner side of the tube to form a flanging, the flanging is cut using laser, so that the aperture of the mating opening is enlarged to a predetermined size, which resolves a problem that a size of the mating opening of the metal shell is inconsistent with the predetermined size, and improves precision of the size of the mating opening of the metal shell.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a flowchart of manufacturing a metal shell according to one embodiment of the present invention.

FIG. 2 is a sectional view of a metal shell according to one embodiment of the present invention.

FIG. 3 is a schematic three-dimensional exploded view of a metal shell and an electrical body according to one embodiment of the present invention.

FIG. 4 is a schematic assembly sectional view of a metal shell and an electrical body according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

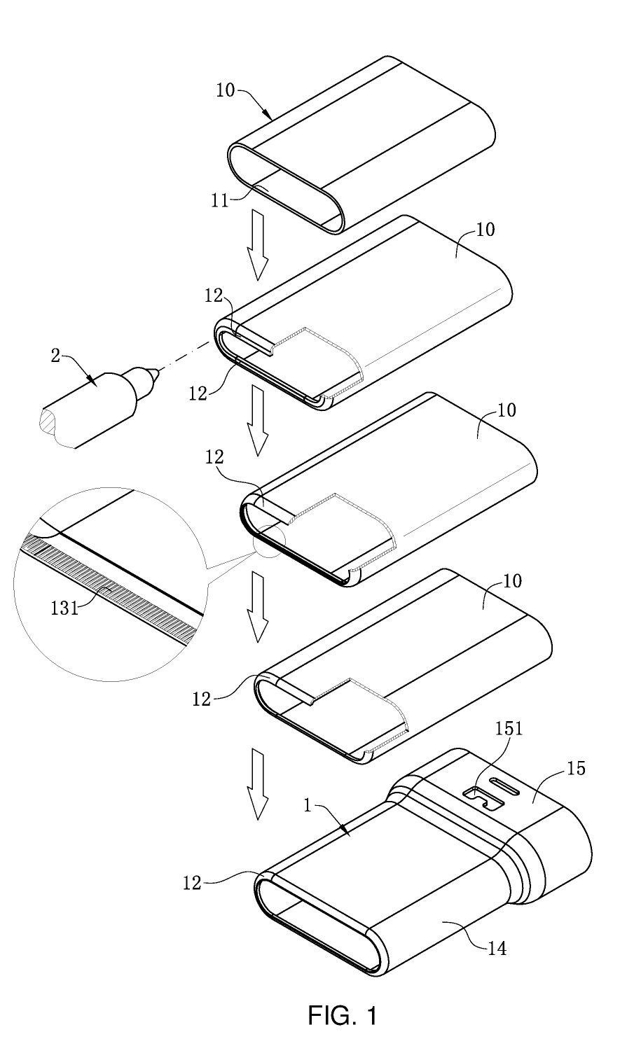

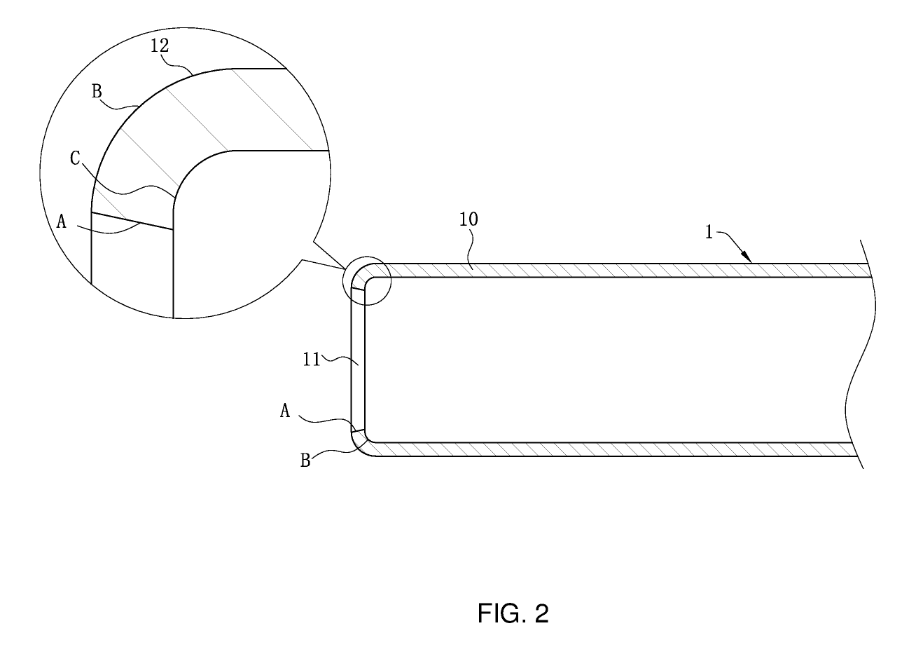

The description will be made as to the embodiments of the present invention in conjunction with the accompanying drawings in FIGS. 1-4. In accordance with the purposes of this invention, as embodied and broadly described herein, this invention, in one aspect, relates to a method for manufacturing a metal shell and an electrical connector thereof.

Referring to FIG. 1, a method for manufacturing a metal shell 1 of an electrical connector according to one embodiment of the present invention is shown. The metal shell 1 is configured for a mating connector (not shown) to be inserted therein. The method includes the following steps:

Step S1: provide a tube 10. An opening of one end of the tube 10 is formed with a mating opening 11 for a tongue (not shown) of the mating connector to be insert therein.

Then, step S2 is performed: a perimeter of the mating opening 11 of the tube 10 is rolled to the inner side of the tube 10, so as to form a flanging 12. The flanging 12 is configured to guide the metal shell 1 to enter the mating connector, so that the tongue of the mating connector enters the tube 10.

Then, step S3 is performed: provide a laser head 2 to transmit laser. The metal shell 1 moves relative to the laser head 2. In this embodiment, the metal shell 1 is located on a seat, the laser head 2 is static, and the seat moves to drive the metal shell 1 to move (in another embodiment, it may also be that the laser head 2 moves, and the seat is static; or both of the laser head 2 and the seat move but they move in different speeds or directions), to cut the flanging 12 using laser, so that the aperture of the mating opening 11 is enlarged to a predetermined size. After the flanging 12 is cut by the laser, a cut surface (that is, a plate thickness surface) of the flanging 12 is formed with a chamfer A that enables the aperture of the mating opening 11 to gradually become larger in an insertion direction of the metal shell 1 (in another embodiment, the chamfer A may enable the aperture of the mating opening 11 to gradually become smaller in an insertion direction of the metal shell 1). In certain embodiments, when cutting is performed using the laser, high-pressure air may be blown to the metal shell 1. The pressure of the high-pressure air is ≧0.5 MPa and ≦2 MPa, so that during cutting by the laser, residues are oxidized instantly. In other embodiments, when cutting is performed using the laser, high-pressure inert gases are blown. The pressure of the high-pressure inert gases is ≧0.5 MPa and ≦2 MPa, so that the cut surface A of the flanging 12 is not oxidized.

Then, step S4 is performed: after the flanging 12 is cut by the laser, the cut surface A of the flanging 12 is formed with multiple protruding ribs 131. The protruding ribs 131 are then physically polished (for example, sand-blasting polishing). Moreover, residues generated during cutting are removed in a physical polishing manner (for example, sand-blasting polishing or magnetic polishing).

Then, step S5 is performed: flare another end of the tube 10, so that the tube 10 is formed with a first frame 14 and a second frame 15 extending backwards from the first frame 14. The aperture of the second frame 15 is greater than the aperture of the first frame 14. A positioning hole 151 is disposed respectively on an upper surface and a lower surface of the second frame 15.

Referring to FIGS. 1-4, the metal shell 1 manufactured according to certain embodiments of the present invention is applied to an electrical connector. The electrical connector is used for connecting a mating connector (not shown). The metal shell 1 is used for the mating connector to be inserted therein. The electrical connector conforms to the Type C specification of the USB organization. The electrical connector includes an electrical body 3, and the electrical body 3 is accommodated in the metal shell 1. The electrical body 3 includes an insulating body 30 accommodated in the metal shell 1.

Referring to FIGS. 1-4, the metal shell 1 includes a tube 10. A perimeter of a mating opening 11 of the tube 10 is rolled inward to form a flanging 12. An outer surface B of the flanging 12 is configured to guide the metal shell 1 to be inserted in the mating connector. The flanging 12 is stopped by the insulating body 30. The flanging 12 is cut using a laser, so that a plate thickness surface of the flanging 12 is a chamfer A that enables the aperture of the mating opening 11 to gradually become larger in an insertion direction of the metal shell 1, and the mating opening 11 of the tube 10 is enlarged to a predetermined size, to match the mating connector and the insulating body 30. The chamfer A connects the outer surface B to an inner surface C of the flanging 12, and the outer surface B and the inner surface C are arc-shaped.

Referring to FIGS. 1-4, the electrical body 3 further includes a first terminal group 31 and a second terminal group 32. The first terminal group 31 and the second terminal group 32 are respectively received in the insulation body 30 and disposed in an upper row and a lower row. The insulating body 30 has an insertion cavity 301 for a tongue portion of the mating connector to be inserted therein. Two opposite sides of the insulating body 30 respectively have a through slot 302 to be connected to the insertion cavity 301. The insulating body 30 is provided with two engagement portions 303 extending backwards, to fasten a circuit board. The first terminal group 31 and the second terminal group 32 are soldered to the circuit board. An upper surface and a lower surface of the insulating body 30 is symmetrically provided with protruding blocks 304. The protruding blocks 304 are configured to fixedly cooperate with the positioning holes 151 of the metal shell 1. The insulating body 30 has a concave portion 300, the chamfer A is received in the concave portion 300.

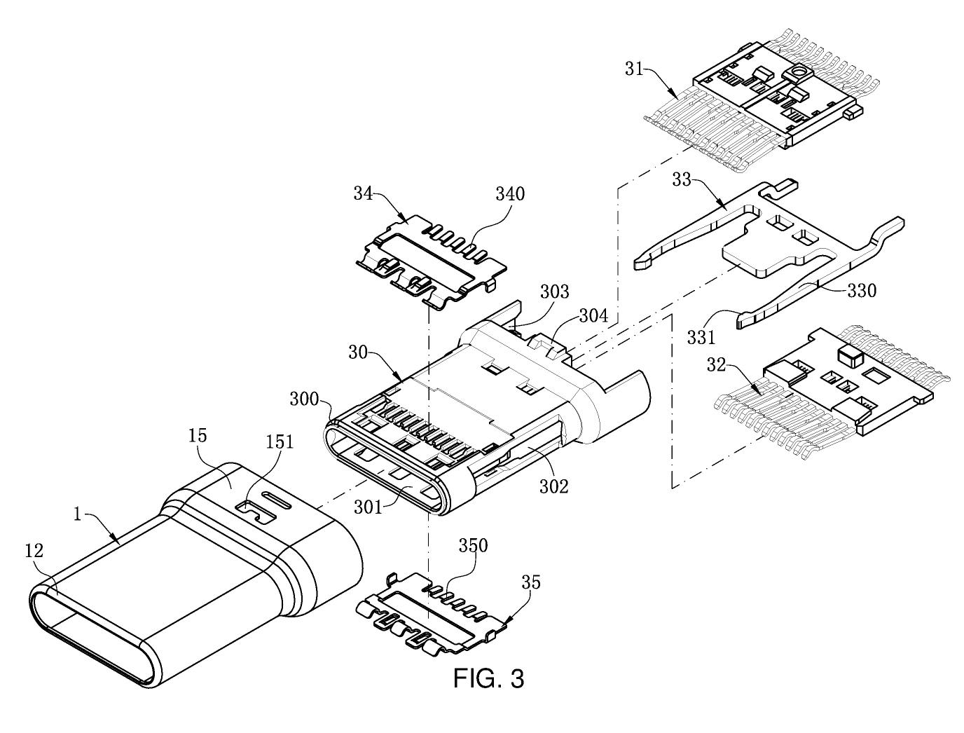

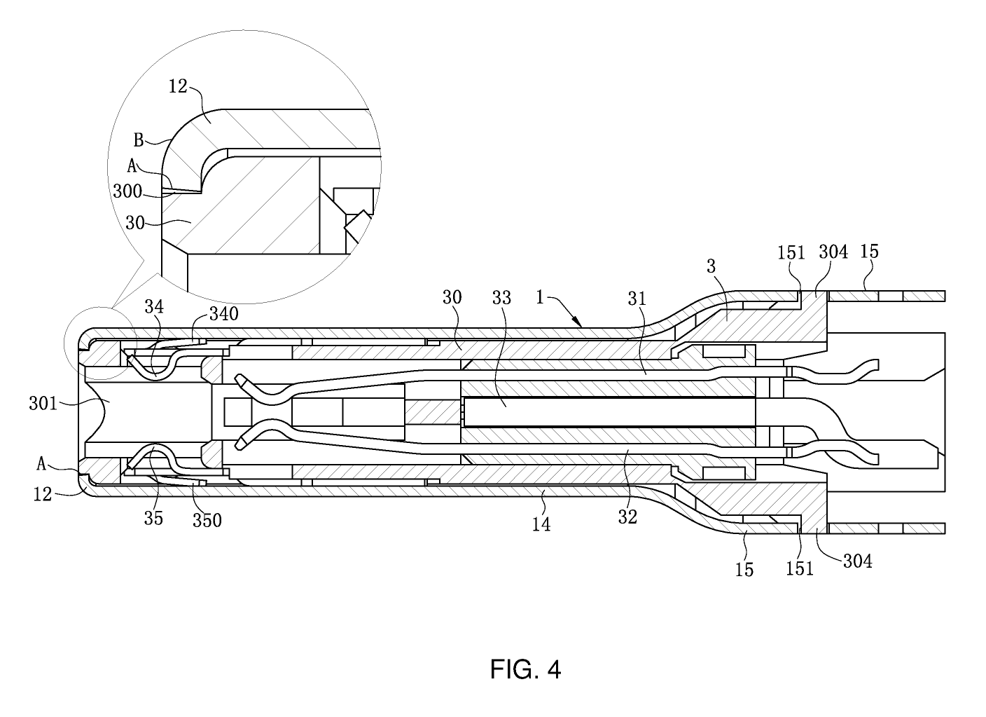

Referring to FIGS. 3 and 4, the electrical body 3 further includes a middle shielding sheet 33. The middle shielding sheet 33 is accommodated in the insertion cavity 301 and is located between the first terminal group 31 and the second terminal group 32. Two opposite sides of the middle shielding sheet 33 respectively integrally extend an elastic arm 330 to the direction of the through slot 302, so that the elastic arms 330 are respectively exposed in the through slots 302. Each of the elastic arms 330 is provided with a buckling portion 331. The buckling portions 331 are configured to buckle the mating connector (not shown).

Referring to FIGS. 3 and 4, the electrical body 3 further includes an upper shielding sheet 34 and a lower shielding sheet 35. The upper shielding sheet 34 is fastened to the top surface of the insulating body 30, and the lower shielding sheet 35 is fastened to the bottom surface of the insulating body 30. The upper shielding sheet 34 is located above the first terminal group 31 and is configured to shield an interference signal above the first terminal group 31. The lower shielding sheet 35 is located below the second terminal group 32 and is configured to shield an interference signal below the second terminal group 32. Each of the upper shielding sheet 34 and the lower shielding sheet 35 is respectively protruded with five grounding portions 340 and five grounding portions 350 to be in contact with the metal shell 1.

The manufacturing method according to certain embodiment of the present invention, among other things, has the following beneficial advantages.

1. After a perimeter of the mating opening 11 of the tube 10 is rolled to the inner side of the tube 10 to form the flanging 12, the flanging 12 is cut by the laser, so that the aperture of the mating opening 11 is enlarged to a predetermined size, which resolves a problem that a size of the mating opening 11 of the metal shell 1 is inconsistent with the predetermined size, and improves precision of the size of the mating opening 11 of the metal shell 1.

2. The flanging 12 is cut using the laser. Compared with cutting the flanging 12 by stamping, since cutting by the laser can correct precision of a tool using charge-coupled device (CCD) detection points, the cutting size has a high precision accuracy. In addition, cutting by the laser does not cause unfavorable cases such as crushing and deformation of the metal shell 1 (cutting using stamping causes unfavorable cases such as crushing and deformation of the metal shell 1). Moreover, cutting by the laser does not need molding, which avoids mold repairing required in the stamping method. Besides, cutting using laser does not generate a large block of “flash,” and generates only remains of residues generated by cutting, which can be easily removed in by a physical polishing.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for manufacturing a metal shell of an electrical connector, comprising:
S1: providing a tube, wherein a mating opening is formed at an opening of the tube, for a tongue of a mating connector to be inserted therein;
S2: rolling a perimeter of the mating opening inward to form a flanging, wherein the flanging is configured to guide the mating connecter to enter the tube; and
S3: cutting the flanging using laser, so that an aperture of the mating opening is enlarged to a predetermined size.

2. The method of claim 1, wherein after the step of S3, a plurality of protruding ribs is formed at a cut surface of the flanging, and the method further comprises:
physically polishing the protruding ribs.

3. The method of claim 1, further comprising, concurrently at the step of S3:
blowing high-pressure air, wherein a pressure of the high-pressure air is in a range of about 0.5 MPa-2 MPa.

4. The method of claim 1, further comprising, concurrently at the step of S3:
blowing a high-pressure inert gas, wherein a pressure of the high-pressure inert gas is in a range of about 0.5 MPa-2 MPa.

5. The method of claim 1, wherein a laser head is configured to transmit the laser, and when the laser cuts the flanging, the metal shell moves relative to the laser head.

6. The method of claim 5, wherein when the laser cuts the flanging, the laser head is static, the metal shell is located on a seat, and the seat moves to drive the metal shell to move.

7. The method of claim 1, further comprising:
flaring an end of the tube that is opposite to the mating opening of the tube, so as to form a first frame and a second frame extending backwards from the first frame,
wherein an aperture of the second frame is greater than an aperture of the first frame.

8. A metal shell of an electrical connector, comprising a tube, wherein the tube has a mating opening formed at an opening of the tube, the mating opening is configured for a tongue of a mating connector to be inserted therein, a perimeter of the mating opening is rolled inward to form a flanging, the flanging is configured to guide the mating connector to enter the tube, and a plate thickness surface of the flanging is cut using laser to form a chamfer.

9. The metal shell of claim 8, wherein the chamfer enables an aperture of the mating opening to gradually become larger in an insertion direction of the metal shell.

10. An electrical connector, comprising:
a metal shell comprising a tube, wherein the tube has a mating opening formed at an opening of the tube, the mating opening is configured for a tongue of a mating connector to be inserted therein, a perimeter of the mating opening is rolled inward to form a flanging, the flanging is configured to guide the mating connector to enter the tube, and a plate thickness surface of the flanging is cut using laser to form a chamfer; and
an electrical body accommodated in the metal shell.

11. The electrical connector of claim 10, wherein the electrical body comprises:
an insulating body, accommodated in the metal shell and stopped by the flanging;
a first terminal group and a second terminal group received in the insulation body and disposed in an upper row and a lower row;
an upper shielding sheet, retained to the insulation body and located above the first terminal group;
a middle shielding sheet, retained to the insulation body, and located between the first terminal group and the second terminal group; and
a lower shielding sheet, retained to the insulation body, and located below the second terminal group,
wherein each of the upper shielding sheet and the lower shielding sheet is provided with a grounding portion in contact with the metal shell.

12. The electrical connector of claim 10, wherein a positioning hole is disposed respectively on each of an upper surface and a lower surface of the metal shell, a protruding block is disposed respectively on each of an upper surface and a lower surface of the insulating body, and the protruding blocks of the insulating body are respectively fixedly to the positioning holes of the metal shell.

13. The electrical connector of claim 8, wherein the chamfer connects an outer surface of the flanging to an inner surface of the flanging.

14. The electrical connector of claim 10, wherein the chamfer connects an outer surface of the flanging to an inner surface of the flanging.

15. The electrical connector of claim 10, wherein the insulating body has a concave portion, and the chamfer is received in the concave portion.
